(19) United States
(12) Patent Application Publication
(10) Pub. No.: US 2004/0182468 A1
(43) Pub. Date: Sep. 23, 2004

(54) Fabrication of air bag fabric

(76) Inventors: Birgit Trondle, Albbruck (DE); Michael Becker, Zell im Wiesental (DE); Thomas Eschbach, Rheinheim (DE); Norbert Huber, Bad Sackingen (DE)

Correspondence Address: HARNESS, DICKEY & PIERCE, P.L.C., P.O. BOX 828, BLOOMFIELD HILLS, MI, 48303, US

(21) Appl. No.: 10/784,640

(22) Filed: Feb. 23, 2004

Related U.S. Application Data
(63) Continuation of application No. PCT/EP02/08764, filed on Aug. 6, 2002.

(30) Foreign Application Priority Data
Aug. 30, 2001 (DE) 101 42 130.3

(51) Int. Cl. D03D 11/00; G06F 17/30

(52) U.S. Cl. 139/408

(57) ABSTRACT

The invention relates to a method for weaving fabrics that comprise in at least some sections multiple layers, especially one-piece woven (OPW) airbags comprising single-layer, double-layer and multi-layer sections. According to the inventive method, weaves or weave combinations are produced in the double- or multi-layer sections that are different from the plain weave.

### CROSS REFERENCE TO RELATED APPLICATIONS

### BACKGROUND A SUMMARY OF THE INVENTION

The present invention relates to a method of weaving fabrics configured multi-ply in at least some portions, especially air bags woven in one piece (one piece woven=OPW) including an upper ply and a lower ply interwoven into a single ply in a selvage portion.

When fabricating contoured multi-ply wovens, for example one-piece woven (OPW) air bags wrinkles may materialize when configuring several portions differing in the number of fabric plies, for example with inwoven spacers and/or when employing differing materials and/or differing in fineness as a result of the different sets or cover factors in each case in the individual plies of portions in contact with each other. This is due to the differences in the ratio of mass to unit of surface area increasing or diminishing per ply when the existing mass of yarn material is distributed in more or fewer plies than before or when for the same set a coarser yarn, i.e. yarn having a higher mass is employed.

This results in a number of disadvantages. Thus, at the locations or portions as described above crimping the yarns in weaving and shrinkage in subsequent processes may deviate from a fabric surface area free of wrinkles which could result in the specified technical properties failing to be satisfied at such locations. In addition, wrinkle trapping could detriment the strength of the fabric at such locations. Apart from this, the air bag may fail to deploy as specified because of the effect of the wrinkles as cited above which could result in its protection being diminished. Another disadvantage is that the tack of a film laminated to the fabric may suffer from the irregular surface area of the wrinkle portion and the coating as may be provided deviates from that as specified in these portions and/or the tack of the coating may suffer. This too, would result in non-compliance with the technical specification and the product as well as items suffering from the above deficiencies becoming rejects.

It is thus the objective of the invention to propose a method of weaving fabrics configured multi-ply at least in some portions, especially OPW air bags comprising an upper ply and a lower ply in which the disadvantages as known from prior art are avoided or at least greatly diminished. This objective is achieved by a method as set forth in claim 1. Implementing the method in accordance with the invention avoids to advantage wrinkles as the source of numerous deficiencies in the finished product. Differences in the set of the fabric are now compensated by implementing the method in accordance with the invention. Uniform crimp and shrinkage is now attained throughout the air bag in its entirety. The strength of the fabric is no longer reduced by trapped wrinkles in thus enabling performance as specified to be satisfied. The fabric is now engineered to function reliably. As a result of the smooth surface of the OPW fabric attainable by application of the method in accordance with the invention consistent coating of all portions of the air bag or OPW fabric is now assured. The entirety of the air bag surface can now be consistently laminated with a film in ensuring a uniform seal of the OPW fabric. In an early stage in fabrication the weaving method in accordance with the invention prevents air bags becoming rejects because of wrinkles in the finished product.

In one advantageous further embodiment of the method in accordance with the invention a two-ply fabric (12) is woven in a rep mix and a four-ply fabric (14) in L 1/1 plain weave as a particularly advantageous weave combination as an excellent means of preventing wrinkling. It is understood, of course, that such weave combinations also include combinations of other weaves with plain weaves. Further features of the invention read from the sub-claims.

### BRIEF DESCRIPTION OF THE DRAWINGS

The invention will now be detailed by way of an example with reference to the drawing in which:

FIG. 1 is an illustration showing the result of a prior art weaving method in interweaving a two-ply portion and a four-ply portion.

FIG. 2 is an illustration likewise showing two portions of an OPW, but this time with weave combinations as achieved by employing the method in accordance with the invention.

### DETAILED DESCRIPTION

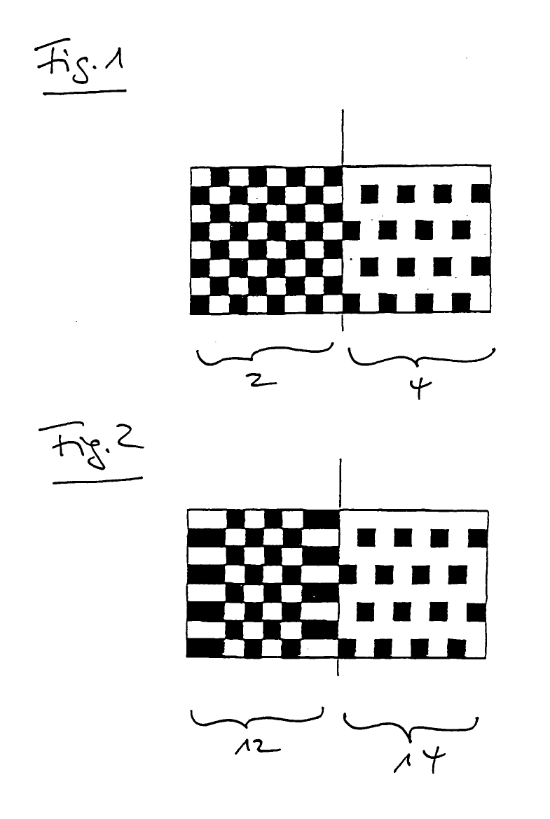

Referring now to FIG. 1 there is illustrated the interweave of a two-ply portion 2 and a four-ply portion 4 in an air bag woven by a method as known from prior art in which a plain weave L 1/1 is employed in the two portions 2 and 4 of the fabric as shown. Because of the differences in the set of the fabric of the two portions of this air bag woven as such, the finished product is seriously wrinkled.

Referring now to FIG. 2 there is illustrated the interweave of a two-ply portion and a four-ply portion in an air bag woven by a method in accordance with the invention. In the two-ply portion 12 shown on the left in FIG. 2 use is made of a combination of a plain weave L 1/1 and a rep weave RL 1/1 in a two-thread configuration whilst in the four-ply portion 14 shown on the right in FIG. 2 use is made of plain weave L 1/1. The fabric as produced by implementing the method in accordance with the invention as shown in FIG. 2 features a uniform set by reducing the set of the two-ply portion 12 in accordance with the invention in thus adapting it to the set of a ply of the four-ply portion 14. By making use of the method in accordance with the invention the reduction in the difference of sets involved results to advantage in the finished product being free of wrinkles so that the OPW air bag can now be put to use with no restrictions.

1. A method of weaving fabrics configured multi-ply in at least some portions, especially air bags woven in one piece, comprising single-ply, two-ply and multi-ply portions, comprising combination weaves other than plain weave are woven in said two-ply or multi-ply portions.

2. A method of weaving fabrics configured multi-ply in at least some portions, especially air bags woven in one piece, comprising single-ply, two-ply and multi-ply portions, wherein combination weaves other than plain weave are woven in said two-ply or multi-ply portions and a rep mix is woven in a two-ply fabric (12) and a plain weave L 1/1 in a four-ply fabric (14).

3. A method of weaving fabrics configured multi-ply in at least some portions, especially air bags woven in one piece, comprising single-ply, two-ply and multi-ply portions, comprising combination weaves other than plain weave are woven in said two-ply or multi-ply portions comprising the differing yarn materials and/or material finenesses are selected and/or the existing number of threads are divided into another number of fabric plies.

4. A method of weaving fabrics configured multi-ply in at least some portions, especially air bags woven in one piece, comprising single-ply, two-ply and multi-ply portions, wherein combination weaves other than plain weave are woven in said two-ply or multi-ply portions and a rep mix is woven in a two-ply fabric (12) and a plain weave L 1/1 in a four-ply fabric (14) and differing yarn materials and/or material finenesses are selected and/or the existing number of threads are divided into another number of fabric plies.
